(19) United States
(12) Patent Application Publication
(10) Pub. No.: US 2005/0278737 A1
(43) Pub. Date: Dec. 15, 2005

(54) User configurable electronic program guide drawing upon disparate content sources

(75) Inventors: Yue Ma, West Windsor, NJ (US); Chieh-Chung Chang, Monmouth Junction, NJ (US); Alan Kaplan, Princeton, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD, Osaka (JP)

(21) Appl. No.: 10/509,643

(22) PCT Filed: Mar. 31, 2003
(86) PCT No.: PCT/US03/09883

§ 371 Date: Jun. 16, 2005

Related U.S. Application Data
(60) Provisional application No. 60/370,496, filed on Apr. 5, 2002.

(51) Int. Cl. H04N 7/173; G06F 13/00

(52) U.S. Cl. 725/40; 725/100; 725/112; 725/39

(57) ABSTRACT

A method is provided for enhancing current electronic program guide technology by drawing upon information from at least two disparate content sources (20 and 13). Electronic program guide information is displayed to the viewer using a portable handheld device (14), such as a remote control, PDA, or cellular phone. This approach enables electronic program guide information to be provided to the viewer at different depth levels, as well as allows content providers to incorporate their own display format for the electronic program guide information. Lastly, the portable handheld device allows the viewer to easily manipulate the electronic program guide information, thereby enhancing their interactive TV experience.

### FIELD OF THE INVENTION

The present invention relates generally to interactive television, and more particularly, to a method for enhancing current electronic program guide technology by drawing upon information from at least two disparate content sources.

### BACKGROUND OF THE INVENTION

Current electronic program guide (EPG) technology is not ideal because the information display must be configured for the least common denominator (e.g., analog television). Due to display limitations and information channel limitations, EPG information cannot currently be displayed at different depth levels (ranging from simple program schedule information to more detailed supplementary information, such as actor biographical info and screen shots). Moreover, current technology does not give content providers a good opportunity to customize the way EPG information is displayed to different viewers.

The present invention improves upon conventional EPG technology by providing EPG information from at least two disparate sources, such as from the broadcast medium and the Internet. EPG information is displayed to the viewer using a portable handheld device, such as a remote control, PDA, and/or cellular phone. This approach enables EPG information to be provided to the viewer at different depth levels. In addition, this approach allows content providers to incorporate their own display format for the EPG information. Lastly, the portable handheld device allows the viewer to easily manipulate the EPG information, thereby enhancing their interactive TV experience.

For a more complete understanding of the invention, its objects and advantages refer to the following specification and to the accompanying drawings.

### BRIEF DESCRIPTION OF THE DRAWINGS

FIG. 1 is a diagram depicting an exemplary interactive TV system in accordance with the present invention;

FIGS. 2-4 illustrate how electronic program guide information is made available to the viewer at different depth levels in accordance with the present invention;

FIG. 5 is a block diagram of an exemplary architecture used to implement the interactive TV system of the present invention;

FIGS. 6A and 6B illustrate exemplary source table and EPG content directory, respectively, in accordance with the present invention; and

FIGS. 7A and 7B are flowcharts illustrating exemplary processing for an EPG retrieval module in accordance with the present invention.

### DETAILED DESCRIPTION OF THE PREFERRED EMBODIMENTS

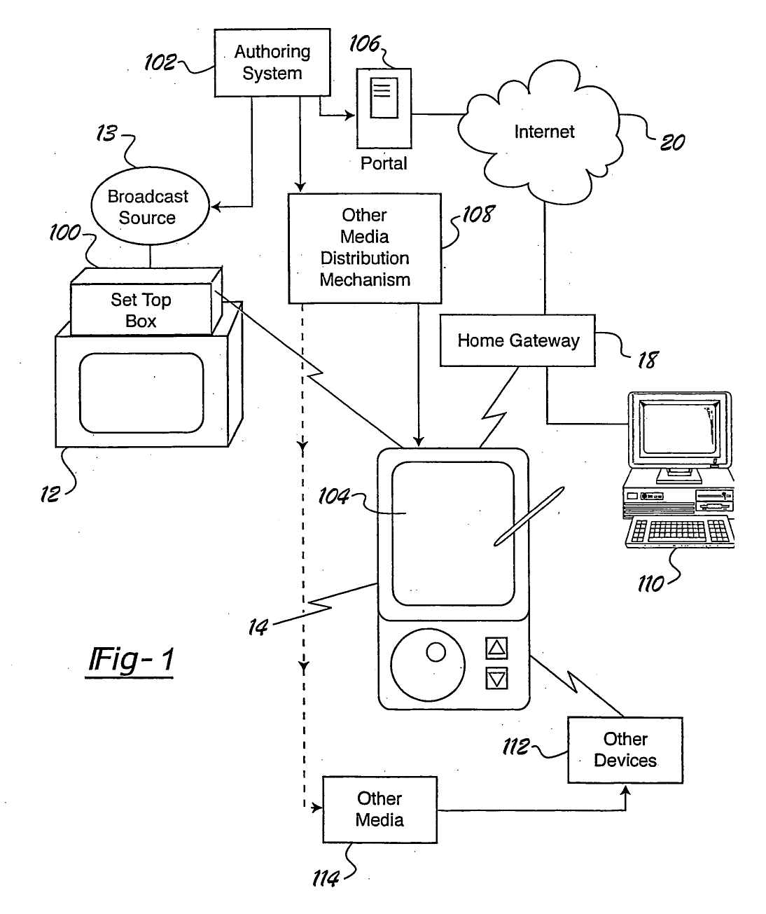

FIG. 1 illustrates an exemplary interactive TV system 10. In accordance with the present invention, the interactive TV system 10 is generally comprised of a television 12, a personal digital assistant (PDA) 14 and at least one disparate media content source. The television 12 is configured to receive audio/visual content from a broadcast source 13 and deliver the audio/visual content to a viewer as is well known in the art. The audio/visual content received from the broadcast source may also be encoded with supplementary broadcast data, including but not limited to electronic program guide data, closed caption data, etc. As will be further described below, at least some of the supplementary broadcast data may be transmitted via a wireless communication link to the PDA 14. While the following description is provided with reference to a PDA, it is readily understood that the broader aspects of the present invention are applicable to remote control devices, cellular phones and other portable handheld devices.

Supplementary broadcast data may also be retrieved by the PDA 14 from at least one other disparate media content source. In a preferred embodiment, the PDA 14 is configured via a wireless communication link to a home gateway 18 which in turn provides a connection to the Internet 20. In this way, the PDA 14 is able to receive electronic program guide data from at least two disparate content sources. It is readily understood that other types of content sources are within the scope of the present invention. For example, an authoring system 102 can deliver digital content for delivery through a variety of different media delivery channels, including broadcast sources 13, the internet 20, and through alternate media delivery mechanism 108. Such mechanisms include memory-based storage systems, CD-ROMs, flash memory, SD media and the like. In the illustrated embodiment the user has a home gateway device 18 communicating via Internet 20. The home gateway thus supplies Internet conductivity to personal computers such as computer 110 and also to the hand-held device 14, preferably via a wireless connection. Thus the hand-held device 14 receives digital content from the Internet 20 as well as from broadcast source 13.

In the embodiment illustrated in FIG. 1 the set top box 100 and home gateway 18 have been shown as separate units. In practice, the two may be included in a single unit that would supply both broadcast source access (such as cable television or satellite channels) as well as high-speed Internet access (such as broadband access). Communication with the hand-held device can be through a variety of different wireless technologies including infrared technology, spread spectrum wireless technology Bluetooth technology, IEEE 802.11, and the like. This same wireless communication capability can be used to permit the hand-held device to wirelessly communicate with other devices such as diagrammatically illustrated at 112. These other devices include a diverse list ranging from point-of-sale (POS) terminals to global positioning systems, to car navigation systems, VCR and DVD recorders and to other smart appliances. In this way, the hand-held device might be configured to receive information from broadcast source 13, from portal 106, and then integrate that information for use in accessing or controlling some other device 112. Alternatively, the other device may be controlled by supplying it with data from some other media, such as media 114 that may be furnished by the other media distribution mechanism 108.

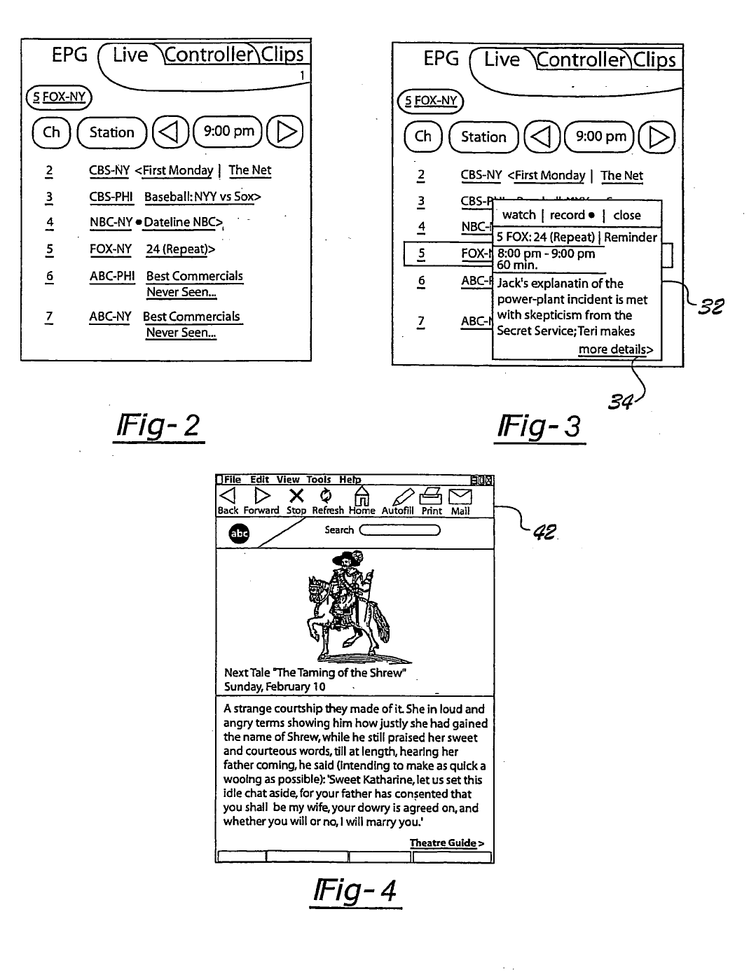

Electronic program guide data for media viewable by media delivery device 12 is made available to the viewer at different depth levels via touchscreen 104 of the PDA. At the highest level, the program schedule tends to be simple and intuitive as shown in FIG. 2. A portion of the program schedule for a given time slot may be displayed to the viewer. In operation, the program schedule will default to the current time slot. To view programs at different time slots or for other channels, a stylus may be used to manipulate the displayed portion of the program schedule. This rudimentary EPG data is typically encoded with the audio/visual content received from the broadcast source. In a conventional analog domain, the vertical blanking interval (VBI) is the portion of the television signal that may be used to carry such EPG data. In a digital broadcast domain, MPEG transport stream data packet is able to carry audio, video and such EPG data. Another alternative to carry data within broadcast signal is based on optical encoding taught by Broughton et al in U.S. Pat. No. 4,807,031. It is readily understood that other encoding techniques are also within the scope of the present invention.

When the viewer taps on a particular program, a mini-review of the program 32 may be displayed as shown in FIG. 3. At this point, the viewer may have the option to watch the program, record the program, or close the pop-up window. The program schedule as well as the pop-up window are displayed using pre-defined templates residing on the PDA.

However, due to certain bandwidth limitations, VBI does not support delivery of a more robust EPG to the viewer. In accordance with the present invention, rudimentary EPG data may be enhanced with additional EPG data retrieved from another disparate content source, such as the Internet. The bandwidth in digital broadcasting domain is significantly higher than that of VBI, however, due to inflexibility of embedding most up to date data once they are authorized at the station, there is still a need to retrieve additional EPG data from other sources to supplement broadcast information. EPG data downloaded from two or more different sources are synchronized through an easy-to-use interface as further described below.

For example, the view may select the “more details” option 34 provided on the pop-up window to see more detailed information about the program. For illustration purposes, the additional EPG information is a more comprehensive textual review of the program. However, it is envisioned that the additional EPG information may include but is not limited to anecdotal information about the program, biographical information for the program's actors, producer's commentary, etc.

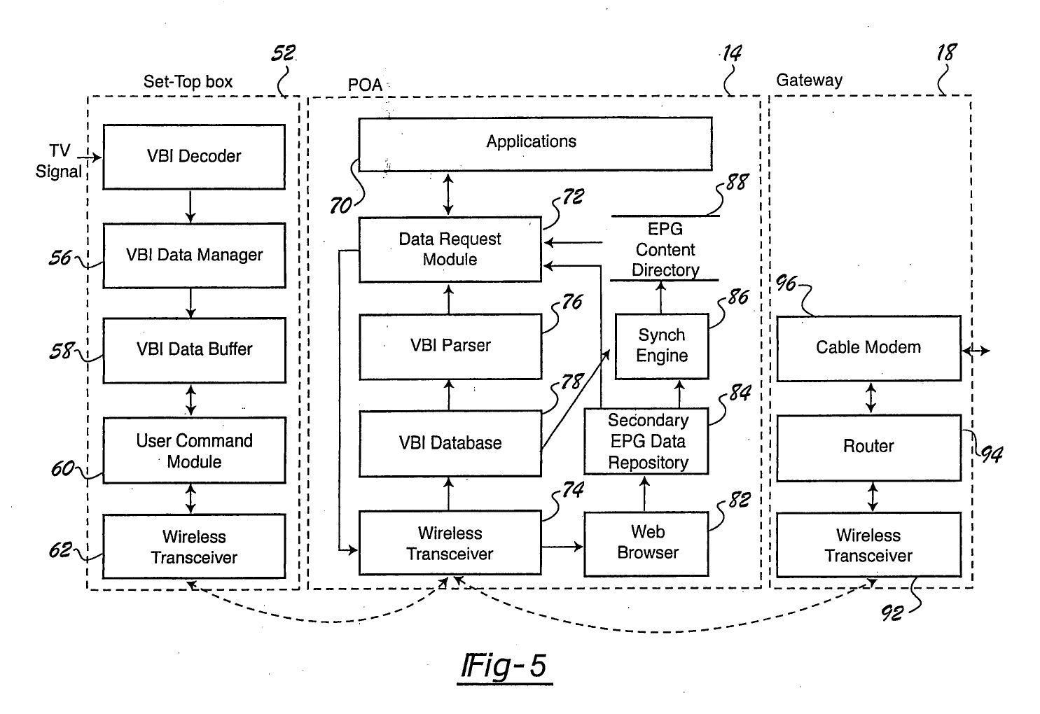

When this option is selected, the additional EPG information may be displayed to the viewer in a web page format 42, such as HTML, using a web browser as shown in FIG. 4. Thus, the content provider can dictate the display format for the additional EPG information. One skilled in the art will readily recognize that the corresponding web pages may be downloaded prior to being selected by the viewer or on an as needed basis at the time they are selected by the viewer.

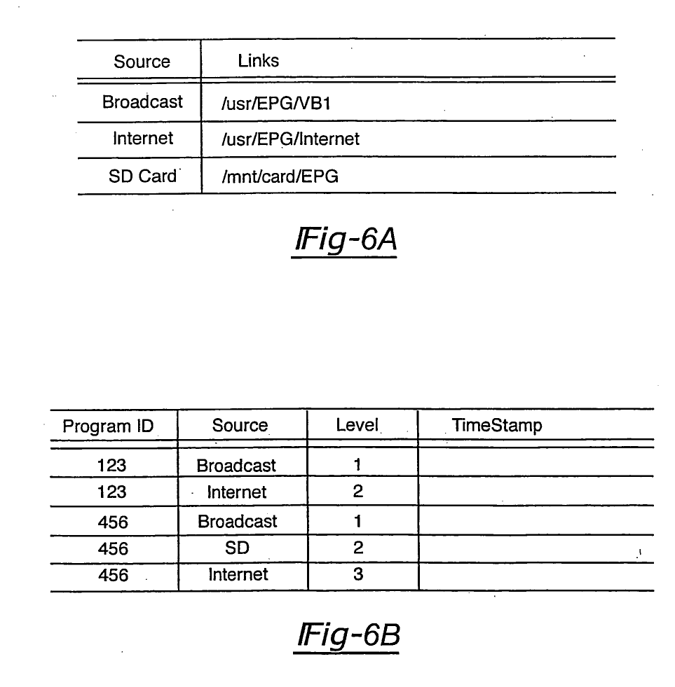

An exemplary system architecture for implementing the present invention in analog broadcast domain, particularly utilizing VBI to carry digital data, is described in relation to FIG. 5. The architecture for digital domain is similar from the perspective of the current invention. As noted above, the primary components of the system architecture include a television 12, a PDA 14, and a home gateway 18. The system architecture further includes a set-top box 52 for decoding VBI data from the broadcast audio/visual content. Although a set-top box is presently preferred, this is not intended as a limitation of the present invention. On the contrary, it is readily understood that the decoding function may be incorporated into the TV or another add-on device which may be used in conjunction with the TV, such as a DVD recorder.

In a preferred embodiment, the set-top box 52 is adapted to receive the incoming TV signal from the broadcast source. In order to retrieve VBI data, the set-top box 52 includes a VBI decoder 54 and a VBI data grabber 56. The VBI decoder 54 is a hardware component that pulls VBI data off of the incoming TV signal. The VBI decoder 54 may be configured to read a specified channel and decode the VBI data transmitted in the specified channel.

Since VBI data is transmitted at only certain time intervals on each channel, it is not instantaneously available upon request from the TV signal. Rather, the system is designed to buffer VBI data as it becomes available. The VBI grabber 56 is a software module that constantly retrieves all available VBI data from the TV signal and stores it in a data store 58 residing on the set-top box.

The set-top box 52 further includes a user command module 60 and a wireless transceiver device 62. The user command module 60 processes commands received from the PDA. For instance, when a request is received for VBI data, the user command module 60 retrieves the requested VBI data from the VBI data buffer and sends it back to the PDA. The VBI data is preferably transmitted by the wireless transceiver device 62 using the Bluetooth protocol, IEEE 802.11b protocol or some other known wireless communication protocol. In another instance, the user command module 60 may receive a command for controlling the TV (such as change channel, lower volume, and similar commands) which are in turn passed along to the TV. The set-top box 52 is configured to interface with the television as is well known in the art.

The PDA 14 serves as the focal point for the viewer's interactive television watching experience. Various user interface applications 70 reside on the PDA 14. Amongst other functions, the applications 70 are designed to display and manipulate the enhanced EPG data for the viewer. Applications are preferably developed using Java or some other known application development tool.

In one embodiment, VBI data is downloaded to the PDA only upon request by the viewer. A software-implemented data request module 72 receives the user requests from one of the applications 70 and sends an appropriate request to the set-top box. Socket programming is an exemplary communication protocol for sending request messages which are of XML format. As described above, request messages are transmitted over a wireless communication channel using a wireless transceiver device 74 incorporated into the PDA 14.

In order to receive VBI data from the set-top box, the PDA further includes a VBI data parser 76 and a VBI database 78. Downloaded VBI data is stored in the VBI database 78. To ease interaction with other applications residing on the PDA, VBI data is preferably stored in XML format. The VBI data parser 76 then serves to retrieve the VBI data from the VBI database 78 and translate it into a format useable by the requesting application. Various commercially available XML-based parsers may be used to implement the VBI data parser 76.

In order to retrieve additional EPG data from the Internet, the PDA may include a web browser 82 and one or more secondary EPG data source repositories 84. The web browser 82 may be used to retrieve additional EPG data from the Internet using retrieval techniques well known in the art. Additional EPG data is subsequently stored in the secondary EPG data repository 84. In one embodiment, the PDA 14 accesses the Internet through a home gateway 18. The home gateway 18 may include a wireless transceiver 92, a router 94, and a cable modem 96 as is well known in the art. It is readily understood that the other means may be employed to access the Internet. It is further understood that EPG data may be retrieved from other local content sources (e.g., SD or CF memory cards) and/or remote content sources.

To facilitate seamless synchronization of VBI data and EPG data downloaded from the Internet, the PDA 14 includes a data synchronization engine 86. The data synchronization engine 86 is primarily responsible for building an EPG content directory 88, which resides locally on the PDA 14. As will be further described below, the EPG content directory 88 is used by the data request module 72 to retrieve user requested EPG data from the appropriate source.

Although the preferred embodiment is illustrated for analog broadcast, particularly utilizing VBI to carry digital information, it should be understood that the architecture for digital broadcast may be similar. In digital broadcast, a MPEG transport stream includes audio, video and data packets. Instead of VBI data, packets of digital data are carried in the transport stream. Instead of a VBI decoder, a transport stream decoder may be used to decode both A/V and data packets. It is readily understood that other encoding techniques are also within the scope of the present invention.

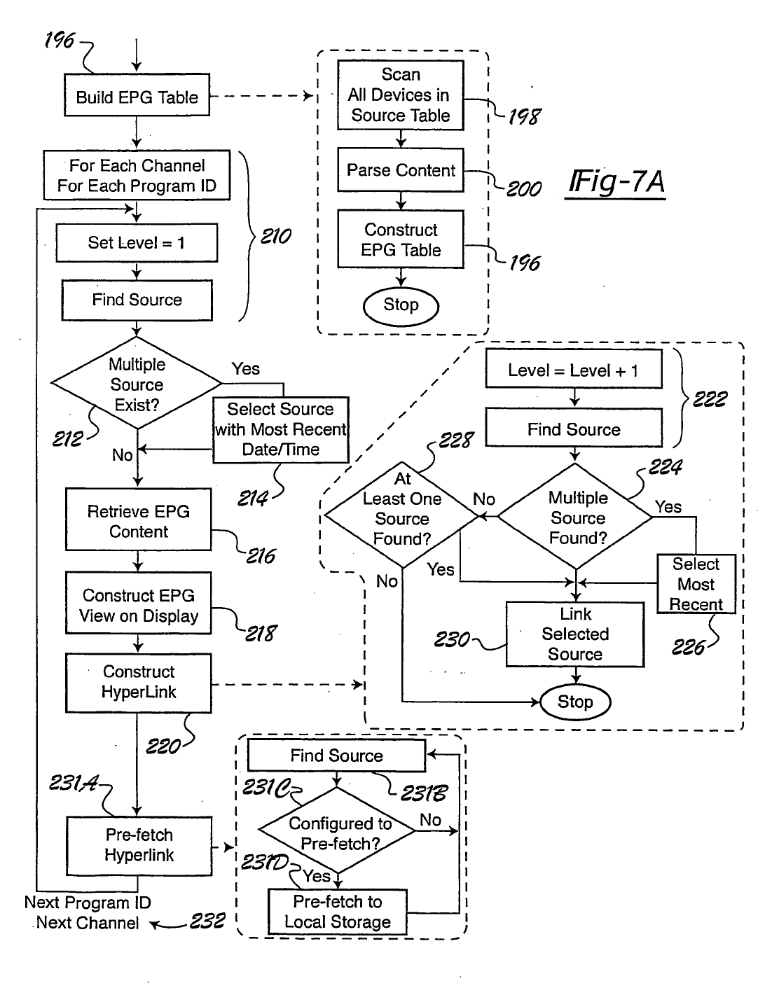

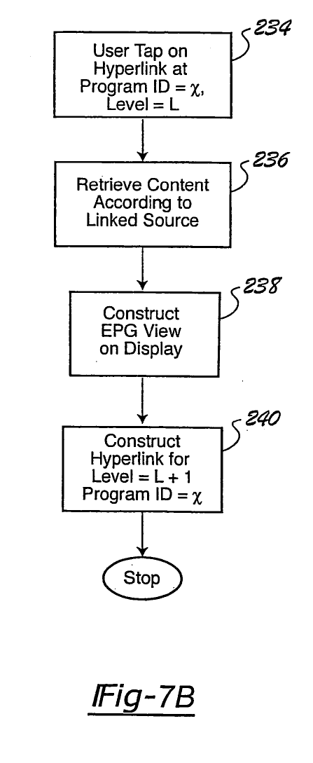

In one embodiment, the PDA 14 is configured with a table that identifies each available source of EPG data. An exemplary source table is shown in FIG. 6A. To build the EPG content directory, the data synchronization engine 86 scans each of the sources identified in the source table. The data synchronization engine 86 parses the contents of each available source. In particular, the data synchronization engine 86 retrieves a corresponding program identifier, viewing level, and timestamp for each available program entry, and then builds the EPG content directory 88. An exemplary EPG content directory is shown in FIG. 6B. The EPG content directory 88 is then used by the data request module 72 to retrieve user requested EPG data from the appropriate source as shown in FIGS. 7A and 7B.

Use of the EPG synchronization engine to create the EPG table and source table is illustrated in FIGS. 7A and 7B. The step of building the EPG table at 196 is accomplished by scanning all available EPG source devices in the source table at 198. The content of the source devices is parsed at 200 and used to construct the EPG table at 196. Once an EPG table has been created, the synchronization engine locates the level 1 program list view for each channel and each program at 210. The engine scans the available sources to determine if multiple sources exist at 212. If multiple sources exist, the engine selects the source with the most recent date and time stamp at 214 and retrieves the EPG content from the selected source at 216 using the source table. Using the retrieved EPG content, the engine constructs the EPG view on the display of the device 218 and provides a hyperlink on the screen to the next level of EPG information.

The hyperlink to the next level of EPG information is constructed at 220. More specifically, the source of the next level of EPG information is located at 222 using the EPG table. If multiple sources are found at 224, the most recent source is selected at 226. If multiple sources are not found at 224 but at least source is found at 228 a link is provided to the selected source on the device at 230. If no source is found at 228, no link is provided. Once a hyperlink has been constructed to the next level at 220, the above process is repeated for subsequent programs and channels as illustrated at 232.

FIG. 7B illustrates the creation of a subsequent hyperlink to direct the user to level 3 EPG information. As illustrated, once the user selects at 234 the hyperlink created at 220, the content provided by the linked source is retrieved at 236 and provided on the display of the device at 238, so as to provide the user with Level 2 EPG information. At 240 a hyperlink to level 3 EPG information is constructed in the same manner as illustrated at 220.

When a multi-level of hyper-links is constructed recursively, some EPG contents can be configured to download to the handheld before user requests. This is implemented through pre-fetch hyperlink 231A as illustrated in FIG. 7A at 231A-231D. Some EPG contents can be pre-fetched and stored locally. A particular source for EPG can be predefined as pre-fetch or not-pre-fetch depending on the type of connections, for example, wireless LAN, fee based mobile network etc. If a source is not fee based, a pre-fetch can be enabled; therefore contents can be downloaded to local storage when the system is idle. If a source is fee based, pre-fetch will not be enabled. The enabling of pre-fetch can also depend on the depth (level) of the link and relativity to the original contents and so on.

One skilled in the art will readily recognize that some or all of the functionality embedded in the PDA may be performed in one or more other devices associated with the broadcast environment, including but not limited to a digital video recorder, the television, the set to box, the home gateway or other known devices. Likewise, it is readily understood that at least some of the functionality embedded in the set top box or the television may be integrated into the PDA.

The description of the invention is merely exemplary in nature and, thus, variations that do not depart from the gist of the invention are intended to be within the scope of the invention. Such variations are not to be regarded as a departure from the spirit and scope of the invention.

1. A handheld device employing disparate sources to provide an electronic programming guide, comprising:
an input adapted to receive a program identification extracted from a broadcast signal, wherein the program identification is adapted to identify available media content;
a synchronization engine adapted to create multilevel links associating the program identification with multiple levels of additional information relating to the available media content, wherein at least one level of the additional information is acquired from a disparate content source, and the multilevel links are synchronized to successively lead to progressively more detailed levels of the additional information; and
a user interface adapted to communicate the multiple levels of additional information in association with the program identification to a consumer based on the multilevel links.

2. The device of claim 1, comprising a data request module adapted to identify the additional information at a remote location on a communications network.

3. The device of claim 1, comprising a data request module adapted to request the additional information from a remote location over a communications network based on the program identification.

4. The device of claim 1, comprising a portal input adapted top receive the additional information from a remote location over a communications network.

5. The device of claim 1, comprising a web browser adapted to store the additional information in a memory of the handheld device.

6. The device of claim 1, wherein said user interface is adapted to communicate the program identification to the consumer.

7. The device of claim 6, wherein said user interface is adapted to detect a selection of the program identification by the consumer.

8. The device of claim 7, wherein said synchronization engine is adapted, upon detecting the selection, to retrieve the additional information from a location in memory of the handheld device via a link between the program identification and the location.

9. The device of claim 7, wherein said synchronization engine is adapted, upon detecting the selection, to retrieve the additional information from a remote location over a communications system via a link between the program identification and the remote location.

10. The device of claim 7, comprising:
retrieving the additional information from a location via a link between the program identification and the location, wherein said retrieving occurs in response to said detecting; and
communicating the additional information to the consumer in response to said detecting.

11. The device of claim 1, wherein said synchronization engine is adapted to create an electronic program guide data structure and source data structure.

12. The device of claim 11, wherein said synchronization engine is adapted to build the electronic program guide data structure by scanning available source devices in the source data structure.

13. The device of claim 12, wherein said synchronization engine is a adapted to parse content of the source devices and construct the electronic program guide data structure based on the content.

14. The device of claim 13, wherein said synchronization engine is adapted to locate a program list view providing a first level of programming guide information including channels and programs of the electronic program guide data structure.

15. The device of claim 14, scans available sources to determine if multiple sources exist, to select a source with a most recent date and time stamp, and to retrieve content from a selected source.

16. The device of claim 15, wherein said synchronization engine is adapted to construct an electronic program guide view on a display of the device, and to provide a hyperlink on the display to a second level of electronic program guide information.

17. The device of claim 16, wherein said synchronization engine is adapted to create a subsequent hyperlink directing the user to a third level of electronic program guide information.

18. The device of claim 16, wherein said synchronization engine is adapted to download electronic program guide contents to the device prior to a user request for electronic program guide contents.

19. A method of operation for a handheld device employing disparate sources to provide an electronic programming guide, comprising:
receiving a program identification extracted from a broadcast signal, wherein the program identification is adapted to identify available media content;
creating multilevel links associating the program identification with multiple levels of additional information relating to the available media content, wherein at least one level of the additional information is acquired from a disparate content source, and the multilevel links are synchronized to successively lead to progressively more detailed levels of the additional information; and
communicating the multiple levels of additional information in association with the program identification to a consumer based on the multilevel links.

20. The method of claim 19, comprising identifying the additional information at a remote location on a communications network.

21. The method of claim 19, comprising requesting the additional information from a remote location over a communications network based on the program identification.

22. The method of claim 19, comprising receiving the additional information from a remote location over a communications network.

23. The method of claim 19, comprising storing the additional information in a memory of the handheld device.

24. The method of claim 11, comprising communicating the program identification to the consumer.

25. The method of claim 24, comprising detecting a selection of the program identification by the consumer.

26. The method of claim 25, comprising retrieving the additional information from a location in memory of the handheld device via a link between the program identification and the location, wherein said retrieving occurs in response to said detecting.

27. The method of claim 25, comprising retrieving the additional information from a remote location over a communications system via a link between the program identification and the remote location, wherein said retrieving occurs in response to said detecting.

28. The method of claim 25, comprising:
retrieving the additional information from a location via a link between the program identification and the location, wherein said retrieving occurs in response to said detecting; and
communicating the additional information to the consumer in response to said detecting.
